(19) United States
(12) Patent Application Publication
(10) Pub. No.: US 2016/0214374 A1
(43) Pub. Date: Jul. 28, 2016

(54) Metal Printing System and Method

(71) Applicants: Ralph Giammarco, New Berlin, WI (US); Michael Kolman, West Allis, WI (US); Anne Grbic, New Berlin, WI (US); Mark Buchman, Franklin, WI (US)

(72) Inventors: Ralph Giammarco, New Berlin, WI (US); Michael Kolman, West Allis, WI (US); Anne Grbic, New Berlin, WI (US); Mark Buchman, Franklin, WI (US)

(21) Appl. No.: 15/089,123

(22) Filed: Apr. 1, 2016

Related U.S. Application Data
(63) Continuation-in-part of application No. 14/960,142, filed on Dec. 4, 2015.
Application No. 14/960,142 is a continuation-in-part of application No. 13/326,080, filed on Dec. 14, 2011, now abandoned.
(60) Provisional application No. 62/160,878, filed on May 13, 2015.
(60) Provisional application No. 61/528,502, filed on Aug. 29, 2011.

(51) Int. Cl. B41F 19/00

(52) U.S. Cl. CPC B41F 19/001

(57) ABSTRACT

The present invention is a metal printing system and method. A metallic sheet has a primer layer coating at least one surface. The primer layer includes nanometallic particles. A printable layer bonds to the primer layer on one side and to a release layer of a carrier layer on its other side. The printable layer also includes nanometallic particles. Because both the primer layer and printable layer have nanometallic particles, a nano-ionic bond force field forms, located between the primer layer and the printable layer. This bonds the primer layer and printable layer together, allowing them to be heated and further bonded. When the carrier layer is removed prior to printing on the printable layer, the multiple bonds ensure that the printable layer remains attached to the metallic sheet.

### CROSS-REFERENCE TO RELATED APPLICATIONS

This patent application claims the benefit of U.S. Provisional Application No. 62/160,878 filed on May 13, 2015. This application is a continuation-in-part and claims the benefit of U.S. patent application Ser. No. 14/960,142, filed on Dec. 4, 2015, which is a continuation-in-part of U.S. patent application Ser. No. 13/326,080 filed on Dec. 14, 2011. The above applications are incorporated by reference herein in their entirety.

### BACKGROUND OF THE INVENTION

1. Field of Invention

This invention relates to the field of coating processes and more specifically to a coating allowing nonuniform or patterned coating (e.g., ink jet printing, etc.).

2. Description of Related Art

Advancements in printing technologies have typically involved improvement of the efficiency of processes in existing markets for existing uses. Far less innovation has focused on expanding into non-traditional printing markets by overcoming limitations in the printing process itself. In particular, improvements to graphic media and interaction of the media with a printer have been relatively limited even though the market for color digital printing systems currently exceeds $109 billion a year.

Presently, the most significant limitation of the printing process is the printer itself. Printers are costly and only able to receive and process limited types of media. In order to embellish a surface with a printed image, the image must be produced on a media which can fit within the printer and which is specifically adapted to receive the inks that a particular printer is adapted to process.

Printers can only process a surprisingly narrow range of materials. A user may want to print graphics directly to metal for applications such as food and beverage containers, underwater applications, durable signs and other graphics displays. Currently, this is not possible because of the limitations of print media.

While some inks have evolved to adapt to meet the needs of metal printing, they are costly, toxic and generally only available to high-volume professional printing operations. Most commonly, even advanced color graphic printing technology known in the art provides a graphic image on a substrate that must be adhered or otherwise attached to a metal surface, requiring additional equipment and processing. Thus, the appearance of even the highest resolution graphic may have the “slapped on” effect of a bumper sticker due to the misapplication of the substrate or damage to the graphic in the application process.

Because equipment costs and adhesion method complexity limit print media, it is difficult to develop printed metal products for widespread use. However, a print product that allows direct printing of metal by home or small-shop printers, such as ink jet printers, will be lucrative.

There is an unmet need for a printing system and method that allows printing metal surfaces without requiring specialized printers, assembly or inks.

### BRIEF SUMMARY OF THE INVENTION

One embodiment of this invention teaches a metal printing system including a metallic sheet and a primer layer coating at least one surface of the metallic sheet. The primer layer includes a plurality of nanometallic particles. The system also includes a printable layer having a first surface and a second surface. The first surface is bonded to the primer layer. The printable layer also includes a plurality of nanometallic particles. A nano-ionic bond force field is located between the primer layer and the printable layer. Another system layer is a carrier layer having a release layer. The release layer contacts the second surface.

Another embodiment of this invention teaches a method of preparing a metallic sheet for printing. The method includes the step of coating at least one surface of the metallic sheet with a primer layer. The primer layer includes a plurality of nanometallic particles. Next, the method dries the primer layer onto the metallic sheet. The method then selects a specific combination of a carrier layer and a release layer to result in a desired finish for a first surface of a printable layer. Next, the method places the first surface of the printable layer in contact with the release layer on a surface of the carrier layer. The printable layer includes a plurality of nanometallic particles. The method then places a second surface of the printable layer in contact with the primer layer, whereupon interactions between the plurality of nanometallic particles of printable layer and the plurality of nanometallic particles of primer layer create a nano-ionic bond force field between the primer layer and the printable layer. Next, the method bonds the printable layer to the primer layer by applying heat to the carrier layer, the printable layer, the primer layer and the metallic sheet.

### BRIEF DESCRIPTION OF SEVERAL VIEWS OF THE DRAWING(S)

FIG. 1 illustrates a cross-section of an exemplary embodiment of a metal printing system.

FIG. 2 illustrates a flowchart of a method for using an exemplary embodiment of a metal printing system.

### TERMS OF ART

As used herein, the term “nano-ionic bond force field” means an ionic bond created by the presence of nanometallic particles in one surface that bond to the nanometallic particles in another surface without the use of adhesive. A nano-ionic bond force field creates a physical bond between the surfaces.

As used herein, the term “nanometallic particles” means metallic particles averaging approximately 0.1 nm to approximately 100 nm in diameter.

As used herein, the term “PST release” means the grams of force required to remove a segment of pressure-sensitive tape from a surface of a material.

As used herein, the term “sheet” means a substantially planar article having a thickness.

### DETAILED DESCRIPTION OF THE INVENTION

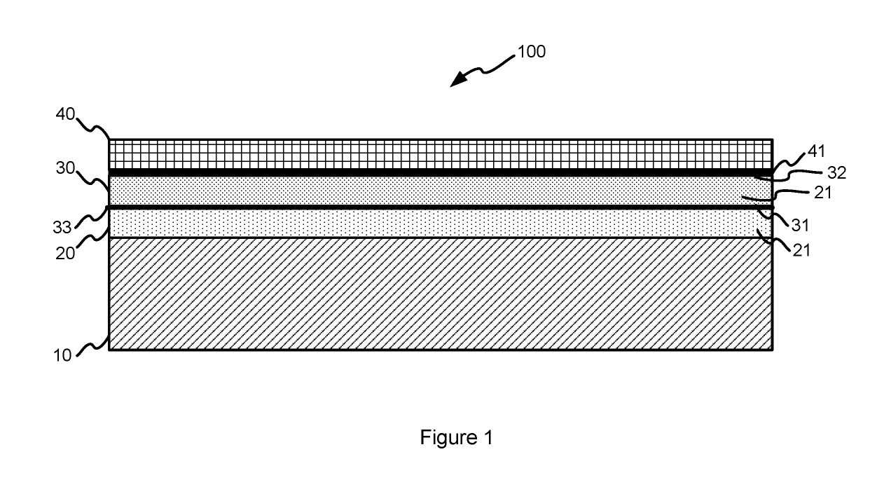

FIG. 1 illustrates a cross-section of an exemplary embodiment of a metal printing system 100. Metal printing system 100 includes a metallic sheet 10, a primer layer 20, a printable layer 30 and a carrier layer 40. Certain embodiments only include printable layer 30 and carrier layer 40 for later combination with metallic sheet 10 and primer layer 20.

In the exemplary embodiment, metallic sheet 10 is a substrate containing approximately 50% to approximately 100% metal. In another embodiment, metallic sheet 10 may be a multi-layered substrate having at least one metal surface. Metals used in metallic sheet 10 may include, but are not limited to, aluminum, copper, zinc, brass, steel and any combination or alloy thereof. Additional materials used in metallic sheet 10 may include, but are not limited to, wood, polymers, ceramics and any combination thereof. Metallic sheet 10 has a thickness of up to approximately 1.5 cm. In the exemplary embodiment, metallic sheet 10 is precut to a desired size before application of primer layer 20. In other embodiments, metallic sheet 10 is part of a larger sheet or roll to which primer layer 20, printable layer 30 and carrier layer 40 are applied before metallic sheet 10 is cut to a desired size.

In the exemplary embodiment, primer layer 20 is applied as a liquid coating on at least one surface of metallic sheet 10 approximately 15 micrometers to approximately 30 micrometers thick. In other embodiments, primer layer 20 is applied on multiple surfaces of metallic sheet 10. Primer layer 20 dries onto metallic sheet 10. In the exemplary embodiment, primer layer 20 is based on a thermoplastic acrylic emulsion. In other embodiments, primer layer 20 is based on thermoplastic urethane, styrene acrylic, ethylene acrylic acid, elastomers and blends thereof. Primer layer 20 includes approximately 100 ppm to approximately 550 ppm nanometallic particles 21. The materials forming nanometallic particles 21 may be, but are not limited to, zinc, zirconium, iridium, copper, silver, gold, platinum or alloys or combinations thereof.

In the exemplary embodiment, printable layer 30 is a polymer approximately 20 micrometers to approximately 30 micrometers thick, such as, but not limited to polyacrylate, polyurethane, polyvinylpyrrolidone, polyvinyl acetate, polyvinyl alcohol, styrenated polyurethane, ethylene acrylic acid and blends thereof. Printable layer 30 has a first surface 31 in contact with primer layer 20. Printable layer 30 has a second surface 32 in contact with a release layer 41 of carrier 40; after removal of carrier 40, second surface 32 also receives ink in a printing process.

As with primer layer 20, printable layer 30 also incorporates approximately 100 ppm to approximately 550 ppm of nanometallic particles 21. The concentrations of nanometallic particles 21 in primer layer 20 and in printable layer 30 may be identical or may differ. Because printable layer 30 incorporates nanometallic particles 21, ink containing organometallic particles will create a nano-ionic bond to printable layer 30. Furthermore, the interactions between nanometallic particles 21 of printable layer 30 and nanometallic particles 21 of primer layer 20 create a nano-ionic bond force field 33 between primer layer 20 and printable layer 30.

In certain other embodiments, printable layer 30 may be patterned or colored. In other embodiments, printable layer 30 may contain an ink substrate. Inks in an ink substrate may include, but are not limited to, solvents, UV inks, latex inks, flexo inks, offset inks, organometallic inks and combinations of inks. Inks may also be liquid inks or dry toner-style inks. In certain other embodiments, printable layer 30 may have multiple sub-layers to create different color or aesthetic effects, or to create additional thickness. For example, in certain embodiments printable layer 30 may contain sub-layers with different ink distributions to produce a color effect.

Carrier layer 40 includes release layer 41 on the surface of carrier layer 40 in contact with printable layer 30. In the exemplary embodiment, carrier layer 40 is a polymer film approximately 25 micrometers to approximately 250 micrometers thick, such as, but not limited to polyethylene, polypropylene, polyester or polyurethane. In another embodiment, carrier layer 40 is approximately 25 micrometers to approximately 250 micrometers thick and manufactured from materials such as, but not limited to, resin-saturated paper, glassine paper, latex-saturated paper, clay-coated paper, machine-glazed paper, and polymer casting sheet. In embodiments utilizing resin-saturated paper, the resin may be, but is not limited to polyolefin resin, polyester resin or polyethylene resin. In the exemplary embodiment, release layer 41 is a heat resistant layer such as, but not limited to silicone. In another embodiment, release layer 41 is a coating of release agent such as, but not limited to, wax, polycarbamate, chromium stearates and high molecular weight acrylic blends. Materials used for release layer 41 have a PST release between approximately 3 grams and approximately 800 grams.

The combination of carrier layer 40 and release layer 41 determines the final finish for printable layer 30. In the exemplary embodiment, carrier layer 40 is a polymer film and release layer 41 is a heat resistant layer, resulting in a gloss finish on printable layer 30. In another embodiment, carrier layer 40 is a resin-saturated paper and release layer 41 is a coating of release agent, resulting in a semi-gloss finish on printable layer 30.

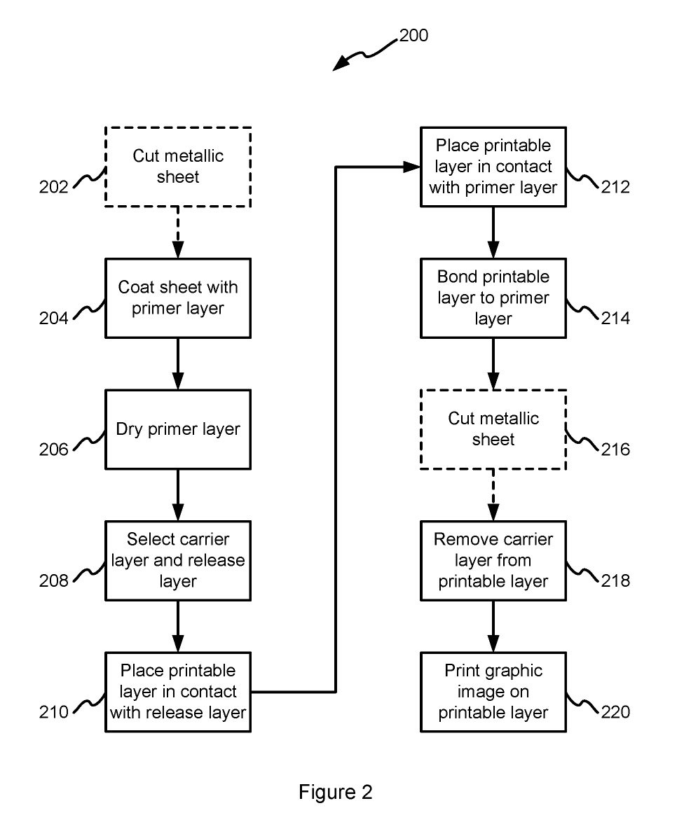

FIG. 2 illustrates a flowchart of a method 200 for using an exemplary embodiment of a metal printing system 100.

In optional step 202, method 200 cuts metallic sheet 10 to a desired size.

In step 204, method 200 coats at least one surface of metallic sheet 10 with primer layer 20.

In step 206, method 200 dries primer layer 20 onto metallic sheet 10.

In step 208, method 200 selects a specific combination of carrier layer 40 and release layer 41 to result in a desired finish for first surface 31 of printable layer 30. In the exemplary embodiment, method 200 selects a polymer film for carrier layer 40 and a heat resistant layer for release layer 41 to result in a gloss finish for first surface 31. In another embodiment, method 200 selects a resin-saturated paper for carrier layer 40 and a coating of release agent for release layer 41 to result in a semi-gloss finish for first surface 31.

In step 210, method 200 places first surface 31 of printable layer 30 in contact with release layer 41 on the surface of carrier layer 40.

In step 212, method 200 places second surface 32 of printable layer 30 in contact with primer layer 20 on metallic sheet 10. The interactions between nanometallic particles 21 of printable layer 30 and nanometallic particles 21 of primer layer 20 create nano-ionic bond force field 33.

In step 214, method 200 further bonds printable layer 30 to primer layer 20 by applying heat to carrier layer 40, printable layer 30, primer layer 20 and metallic sheet 10. The heat may range from approximately 200 degrees F. to approximately 300 degrees F. Application of pressure is in a range of 40.0 to 400.0 pounds per square inch (psi).

In optional step 216, method 200 cuts metallic sheet 10 a desired size. This step has the added effect of also cutting primer layer 20, printable layer 30 and carrier layer 40 to the same desired size.

In step 218, method 200 removes carrier layer 40 from printable layer 30, leaving first surface 31 of printable layer 30 exposed for printing. Step 218 may occur before step 216.

In step 220, method 200 prints at least one graphic image on first surface 31 of printable layer 30.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “substantially” or “approximately” as used herein may be applied to modify any quantitative representation that could permissibly vary without resulting in a change in the basic function to which it is related.

What is claimed is:

1. A metal printing system, comprising:
a metallic sheet;
a primer layer coating at least one surface of said metallic sheet, wherein said primer layer comprises a plurality of nanometallic particles;
a printable layer having a first surface and a second surface, wherein said first surface is bonded to said primer layer, wherein said printable layer comprises a plurality of nanometallic particles;
a nano-ionic bond force field located between said primer layer and said printable layer; and
a carrier layer having a release layer, wherein said release layer contacts said second surface.

2. The system of claim 1, wherein said metallic sheet comprises a material selected from the group consisting of aluminum, brass and steel.

3. The system of claim 1, wherein said metallic sheet is a substrate containing approximately 50% to approximately 100% metal.

4. The system of claim 1, wherein said metallic sheet is a substrate having at least one metal surface.

5. The system of claim 1, wherein said primer layer has a thickness of approximately 15 micrometers to approximately 30 micrometers.

6. The system of claim 1, wherein said primer layer is a thermoplastic acrylic emulsion coating.

7. The system of claim 1, wherein said primer layer comprises approximately 100 ppm to approximately 550 ppm nanometallic particles.

8. The system of claim 1, wherein materials forming said nanometallic particles are selected from the group consisting of: zinc, zirconium, iridium, copper, silver, gold, platinum or alloys or combinations thereof.

9. The system of claim 1, wherein said printable layer comprises approximately 100 ppm to approximately 550 ppm nanometallic particles.

10. The system of claim 1, wherein said printable layer is a polymer approximately 20 micrometers to approximately 30 micrometers thick.

11. The system of claim 1, wherein said carrier layer is a polymer film approximately 42 micrometers thick.

12. The system of claim 1, wherein said carrier layer is a resin-saturated paper approximately 22 micrometers to approximately 250 micrometers thick.

13. The system of claim 1, wherein said release layer is a heat resistant layer made from a material selected from the group consisting of silicone.

14. The system of claim 1, wherein said release layer is a coating of release agent made from a material selected from the group consisting of wax.

15. A method of preparing a metallic sheet for printing, said method comprising the steps of:
coating at least one surface of said metallic sheet with a primer layer, wherein said primer layer comprises a plurality of nanometallic particles;
drying said primer layer onto said metallic sheet;
selecting a specific combination of a carrier layer and a release layer to result in a desired finish for a first surface of a printable layer;
placing said first surface of said printable layer in contact with said release layer on a surface of said carrier layer, wherein said printable layer comprises a plurality of nanometallic particles;
placing a second surface of said printable layer in contact with said primer layer, whereupon interactions between said plurality of nanometallic particles of printable layer and said plurality of nanometallic particles of primer layer create a nano-ionic bond force field between said primer layer and said printable layer;
bonding said printable layer to said primer layer by applying heat to said carrier layer, said printable layer, said primer layer and said metallic sheet.

16. The method of claim 16, further comprising the step of cutting said metallic sheet to a desired size.

17. The method of claim 16, further comprising the steps of:
removing said carrier layer from said printable layer, leaving said first surface of said printable layer exposed for printing; and
printing at least one graphic image on said first surface of said printable layer.

18. The method of claim 16, wherein said step of selecting a specific combination of a carrier layer and a release layer to result in a desired finish for a first surface of a printable layer comprises selecting a polymer film for said carrier layer and a heat resistant layer for said release layer to result in a gloss finish.

19. The method of claim 16, wherein said step of selecting a specific combination of a carrier layer and a release layer to result in a desired finish for a first surface of a printable layer comprises selecting a resin-saturated paper for said carrier layer and a coating of release agent for said release layer to result in a semi-gloss finish.

20. The method of claim 16, wherein said heat may range from approximately 200 degrees F. to approximately 300 degrees F.
